(19) United States
(12) Patent Application Publication
(10) Pub. No.: US 2015/0025746 A1
(43) Pub. Date: Jan. 22, 2015

(54) VEHICLE CONTROLLER AND VEHICLE CONTROL METHOD

(71) Applicant: Daisuke Yoshizawa, Aichi (JP)

(72) Inventor: Daisuke Yoshizawa, Aichi (JP)

(73) Assignee: OMRON AUTOMOTIVE ELECTRONICS CO., LTD., Aichi (JP)

(21) Appl. No.: 14/334,500

(22) Filed: Jul. 17, 2014

(30) Foreign Application Priority Data
Jul. 18, 2013 (JP) 2013-149799

(51) Int. Cl. B60W 10/20; B60W 10/184

(52) U.S. Cl. CPC B60W 10/20; B60W 10/184; B60W 2510/20
USPC 701/41

(57) ABSTRACT

A vehicle controller has a brake operation detector that detects operation of a brake of a vehicle, a contact detector that detects contact of hands with a steering part of the vehicle, an authentication unit that makes wireless communication with a portable device having authentication information and authenticates the portable device, and a controller that controls power supply of the vehicle and driving of a prime mover of the vehicle. If the portable device has been successfully authenticated, the operation of the brake has been detected, and contact of the hands with at least two locations of the steering part has been detected for a specified period or more, the controller performs control to start power supply to a predetermined load of the vehicle and start the prime mover.

### BACKGROUND OF THE INVENTION

1. Field of the Invention

This invention relates to a vehicle controller and a vehicle control method, and specifically to a vehicle controller and a vehicle control method used for starting control of a vehicle.

2. Description of Related Art

In related art, technologies for improving operability and safety at the start of engines of vehicles have been disclosed. For example, a technology of authentication of a portable device for vehicle when a start-up switch of a vehicle is pressed down while a brake pedal is pressed and transition to a drive state in which an accessory power source and an ignition are turned on if the authentication is successful has been disclosed (for example, see Patent Document 1).

Further, Patent Document 1 has disclosed authentication of the portable device when the start-up switch of the vehicle is pressed down while the brake pedal is not pressed and transition to an intermediate drive state in which the accessory power source is turned on if the authentication is successful. Furthermore, the document has disclosed authentication of the portable device when the start-up switch of the vehicle is pressed down while the brake pedal is pressed in the intermediate drive state, and transition to the drive state if the authentication is successful. The document has also disclosed authentication of the portable device when the start-up switch of the vehicle is pressed down for a specified time or more unless the brake pedal is pressed in the intermediate drive state, and transition to the drive state if the authentication is successful.

Further, a technology of starting the engine when shift switches in two locations on the right and left of a steering wheel are pressed down under a condition that the authentication of the portable device for vehicle is successful, a shift position is set to parking or neutral, and the brake pedal is pressed has been disclosed (for example, see Patent Document 2).

Furthermore, a technology of starting the engine when the authentication of the portable device for vehicle is successful, the brake pedal is pressed, an engine switch is pressed down, and then, verification of a password input using a pair of paddle switches provided in a spoke part of the steering wheel is successful has been disclosed (for example, see Patent Document 3).

As described above, in the invention disclosed in any of Patent Documents 1 to 3, operation of a predetermined switch or the like is performed for starting the engine.

Further, in related art, vein authentication of a palm of a user when contact of a hand of the user is detected by a sensor provided on the steering wheel has been proposed ((for example, see Patent Document 4).

Patent Document 1: JP-A-2003-301764

Patent Document 2: JP-A-2001-289142

Patent Document 3: JP-A-2009-202671

Patent Document 4]: JP-A-2003-137073

### SUMMARY OF THE INVENTION

Accordingly, one or more embodiments of the present invention starts a prime mover such as an engine for vehicle only by a driver making a natural movement (taking a natural position) at the start of driving for improvement in operability while securing safety.

A vehicle controller according to one or more embodiments of the invention includes a brake operation detection unit that detects operation of a brake of a vehicle, a contact detection unit that detects contact of hands with a steering part of the vehicle, an authentication unit that makes wireless communication with a portable device having authentication information and authenticates the portable device, and a control unit that controls power supply of the vehicle and driving of a prime mover of the vehicle, wherein, if the portable device has been successfully authenticated, the operation of the brake has been detected, and contact of the hands with at least two locations of the steering part has been detected for a specified period or more, the control unit performs control to start power supply to a predetermined load of the vehicle and start the prime mover.

In the vehicle controller according to one or more embodiments of the invention, if the operation of the brake of the vehicle is detected, the contact of the hands with the steering part of the vehicle is detected, wireless communication is made with the portable device having authentication information, the portable device is authenticated, the authentication of the portable device is successful, the operation of the brake is detected, and the contact of the hands with at least two locations of the steering part is detected for a specified period or more, power supply to a predetermined load of the vehicle is started and the prime mover is started.

Therefore, the prime mover of the vehicle may be started only by a driver making a natural movement (taking a natural position) at the start of driving, and operability may be improved while securing safety.

The vehicle is an automobile such as a passenger car, a bus, or a truck, a two-wheeled vehicle or three-wheeled vehicle with prime mover, or the like, for example. The steering part is a steering wheel of a four-wheeled vehicle, handle bars (grips) of a two-wheeled vehicle, or the like, for example. The portable device is a key FOB for locking and unlocking doors for vehicle and starting the engine, a cellular phone registered for locking and unlocking doors for vehicle and controlling the start of the engine, or the like, for example. The prime mover is an engine, a motor, or the like, for example. The brake operation detection unit, the contact detection unit, the authentication unit, and the control unit are formed by an ECU (Electronic Control Unit), for example.

This authentication unit may be allowed to authenticate the portable device if the contact of the hands with the steering part has been detected under a condition that the power supply to the load and the prime mover are stopped, and the control unit may be allowed to perform control to start power supply to the load and start the prime mover if the contact of the hands with at least two locations of the steering part has been detected for a specified period or more and the operation of the brake has been detected under a condition that the portable device has been successfully authenticated, to perform control to start power supply to at least a part of the load and not to start the prime mover if the contact of the hands with at least two locations of the steering part has been detected for the specified period or more and the operation of the brake has not been detected under the condition that the portable device has been successfully authenticated, and then, to perform control to start the prime mover if the operation of the brake is detected under a condition that the contact of the hands with at least two locations of the steering part has been continuously detected.

Thereby, the vehicle may be started in a predetermined operation sequence. Further, the prime mover may be started after power supply to the load is once started.

The authentication unit may be allowed to authenticate the portable device if the operation of the brake is detected under a condition that the control to start power supply to at least a part of the load is performed, and then, the contact of the hands with at least two locations of the steering part has been continuously detected, and the control unit may be allowed to perform control to start the prime mover if the portable device has been successfully authenticated.

Thereby, security of the vehicle is improved and a theft is harder to occur.

The authentication unit may be allowed to authenticate the portable device if the operation of the brake is detected under a condition that the power supply to the load and the prime mover are stopped, and the control unit may be allowed to perform control to start power supply to the load and start the prime mover if the contact of the hands with at least two locations of the steering part has been detected for a specified period or more under a condition that the portable device has been successfully authenticated and the operation of the brake has been detected.

Thereby, the vehicle may be started in a predetermined operation sequence.

The authentication unit may be allowed to authenticate the portable device if the contact of the hands with at least two locations of the steering part has been detected for a specified period or more under a condition that the power supply to the load and the prime mover are stopped, and the control unit may be allowed to perform control to start power supply to the load and start the prime mover if the operation of the brake is detected under a condition that the portable device has been successfully authenticated, perform control to start power supply to at least a part of the load and not to start the prime mover if the operation of the brake is not detected under the condition that the portable device has been successfully authenticated, and then, perform control to start the prime mover if the operation of the brake is detected under a condition that the contact of the hands with at least two locations of the steering part has been continuously detected.

Thereby, the vehicle may be started in a predetermined operation sequence. Further, the prime mover may be started after power supply to the load is once started.

The authentication unit may be allowed to authenticate the portable device if the operation of the brake is detected under a condition that the control to start power supply to at least a part of the load is performed, and then, the contact of the hands with at least two locations of the steering part has been continuously detected, and the control unit may be allowed to perform control to start the prime mover if the portable device has been successfully authenticated.

Thereby, the vehicle may be started in a predetermined operation sequence.

The authentication unit may be allowed to authenticate the portable device if the operation of the brake is detected and the contact of the hands with at least two locations of the steering part has been detected for a specified period or more under a condition that the power supply to the load and the prime mover are stopped, and the control unit may be allowed to perform control to start power supply to the load and start the prime mover if the portable device has been successfully authenticated.

Thereby, the vehicle may be started in a predetermined operation sequence.

A push-button operation part configured to operate starting and stopping of the prime mover is further provided, and the control unit is allowed to determine abnormality of the contact detection unit and prompt a user to operate the operation part if the portable device has been successfully authenticated, the operation of the brake has been detected, and the contact of the hands with one location of the steering part has been detected for a specified period or more.

Thereby, even when abnormality occurs in detection of the contact of the hand with the steering part due to breakdown of sensors or the like, the user may reliably start the vehicle without confusion.

A vehicle control method according to one or more embodiments of the invention includes a brake operation detection step of detecting operation of a brake of a vehicle, a contact detection step of detecting contact of hands with a steering part of the vehicle, an authentication step of making wireless communication with a portable device having authentication information and authenticating the portable device, and a starting control step of performing control to start power supply to a predetermined load of the vehicle and start a prime mover of the vehicle if the portable device has been successfully authenticated, the operation of the brake has been detected, and contact of the hands with at least two locations of the steering part has been detected for a specified period or more.

In the vehicle control method according to one or more embodiments of the invention, if the operation of the brake of the vehicle is detected, the contact of the hands with the steering part of the vehicle is detected, wireless communication is made with the portable device having authentication information, the portable device is authenticated, the authentication of the portable device is successful, the operation of the brake is detected, and the contact of the hands with at least two locations of the steering part is detected for a specified period or more, power supply to a predetermined load of the vehicle is started and the prime mover of the vehicle is started.

Therefore, the prime mover of the vehicle may be started only by a driver making a natural movement (taking a natural position) at the start of driving, and operability may be improved while securing safety.

The vehicle is an automobile such as a passenger car, a bus, or a truck, a two-wheeled vehicle or three-wheeled vehicle with prime mover, or the like, for example. The steering part is a steering wheel of a four-wheeled vehicle, handle bars (grips) of a two-wheeled vehicle, or the like, for example. The portable device is a key FOB for locking and unlocking doors for vehicle and starting the engine, a cellular phone registered for locking and unlocking doors for vehicle and controlling the start of the engine, or the like, for example. The prime mover is an engine, a motor, or the like, for example. The processing at the respective steps is executed by an ECU (Electronic Control Unit), for example.

According to one or more embodiments of the invention, the prime mover such as an engine of the vehicle may be started only by a driver making a natural movement (taking a natural position) at the start of driving, and operability may be improved while securing safety.

### BRIEF DESCRIPTION OF THE DRAWINGS

FIG. 1 is a block diagram showing a vehicle controller according to one or more embodiments of the invention.

FIG. 2 shows an example of locations where sensors are provided on a steering wheel.

FIG. 3 is a flowchart for explanation of a first embodiment of vehicle starting control processing.

FIG. 4 shows an example of a state transition chart of a vehicle when a push switch is used.

FIG. 5 shows an example of a state transition chart of the vehicle when a knob switch is used.

FIG. 6 is a flowchart for explanation of a second embodiment of the vehicle starting control processing.

FIG. 7 is a flowchart for explanation of a third embodiment of the vehicle starting control processing.

FIG. 8 is a flowchart for explanation of a fourth embodiment of the vehicle starting control processing.

### DETAILED DESCRIPTION

Embodiments of the present invention will be described below with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. The explanation will be made in the following order: 1. Embodiments, and 2. Modified Examples.

### 1. Embodiments

### Configuration Example of Vehicle Controller 11

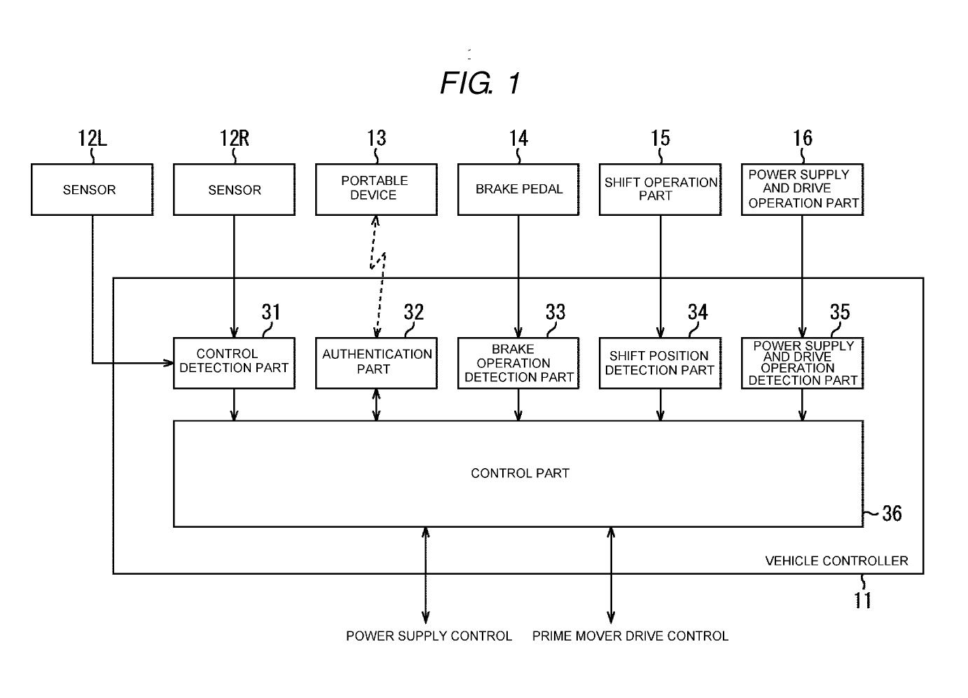

FIG. 1 is a block diagram showing a vehicle controller 11 according to one or more embodiments of the invention.

The vehicle controller 11 is a device provided on a vehicle (not shown) for controlling power supply of the vehicle and driving of a prime mover of the vehicle.

Note that the type of the vehicle on which the vehicle controller 11 is provided is not particularly limited, but the device may be applied to any type of vehicle. Further, the prime mover to be controlled by the vehicle controller 11 is an engine in a gasoline-powered vehicle or diesel-powered vehicle, a motor in an electric car, and an engine and a motor in a hybrid car, for example.

The vehicle controller 11 includes an ECU (Electronic Control Unit), for example, and realizes functions including a contact detection unit 31, an authentication unit 32, a brake operation detection unit 33, a shift position detection unit 34, a power supply and drive operation detection unit 35, and a control unit 36.

The control detection part 31 detects contact with a steering wheel based on sensor data supplied from sensors 12L and 12R provided on the steering wheel as a steering part of the vehicle, and supplies a detection result to the control unit 36.

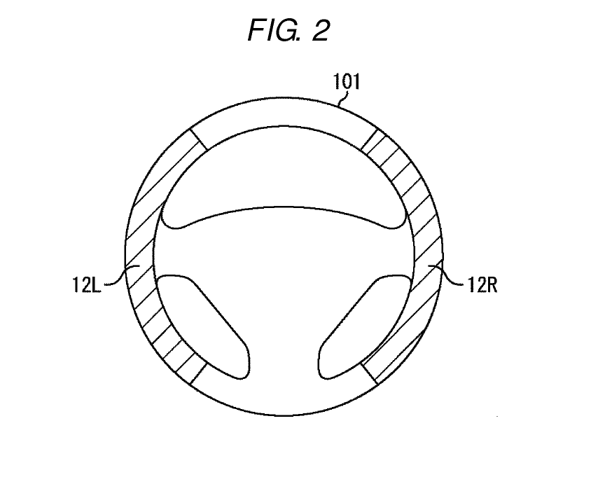

FIG. 2 shows an example of locations where the sensor 12L and the sensor 12R are provided. The sensor 12L and the sensor 12R are provided in predetermined locations on the right and left shown by shaded parts of a ring part of the steering wheel 101. More specifically, the sensor 12L is provided in a range assumed to be held by a left hand of a driver at driving and the sensor 12R is provided in a range assumed to be held by a right hand of the driver at driving.

Further, the sensor 12L and the sensor 12R include any sensors that can detect contact of the hands of the driver with the steering wheel 101. For example, the sensor 12L and the sensor 12R are proximity sensors, touch sensors using electrodes, pressure sensors that detect pressure when the driver holds the steering wheel 101, or the like. Here, the contact such as electrodes used for the sensor 12L is not necessarily single. For example, for detection of the contact of the hands with the shaded parts in FIG. 2, a plurality of contacts may be used or a plurality of the sensors may be provided. The same applies to the sensor 12R. Any form that can detect the hands of the driver may be employed.

The authentication unit 32 makes wireless communication with a portable device 13 having authentication information, authenticates the portable device 13, and supplies an authentication result to the control unit 36.

Note that the portable device 13 is a key FOB for a vehicle in which the vehicle controller 11 is provided, for example, and used for authentication for allowing remote operation for lock and unlock of doors of the vehicle and start of the prime mover and power supply of the vehicle. Further, for the communication method between the portable device 13 and the authentication unit 32, any method may be employed. For example, wireless communication in LF band and UHF band or near field communication such as Bluetooth (registered trademark) is employed.

The brake operation detection unit 33 detects the operation of the brake of the vehicle (not shown), more specifically, the press of a brake pedal 14 based on a signal from a switch or a sensor provided on the brake pedal 14, and supplies a detection result to the control unit 36.

The shift position detection unit 34 detects the shift position of the vehicle based on a signal from a shift operation part 15 and supplies a detection result to the control unit 36.

Note that the shift operation part 15 includes a lever, switch, or the like for switching the shift position of the vehicle, for example.

The power supply and drive operation detection unit 35 detects the operation of a power supply and drive operation part 16 based on a signal supplied from the power supply and drive operation part 16, and supplies a detection result to the control unit 36.

Note that the power supply and drive operation part 16 is an ignition switch used for switching of the state of the power supply of the vehicle and the operation of starting and stopping the prime mover, for example, and may be a push-button type or rotary type. Further, a type operated by insertion of a mechanical key may be employed.

The control unit 36 performs overall control of the vehicle controller 11. Further, the control unit 36 performs control of power supply of the vehicle and drive of the prime mover based on information from the respective parts of the vehicle controller 11. For example, the control unit 36 supplies a predetermined command signal to the power supply of the vehicle or the control unit thereof, and thereby, controls switching of the power supply mode of the vehicle. Further, for example, the control unit 36 supplies a predetermined command signal to the prime mover of the vehicle or the control unit thereof, and thereby, controls start and stop of the prime mover or the like.

### First Embodiment of Vehicle Starting Control Processing

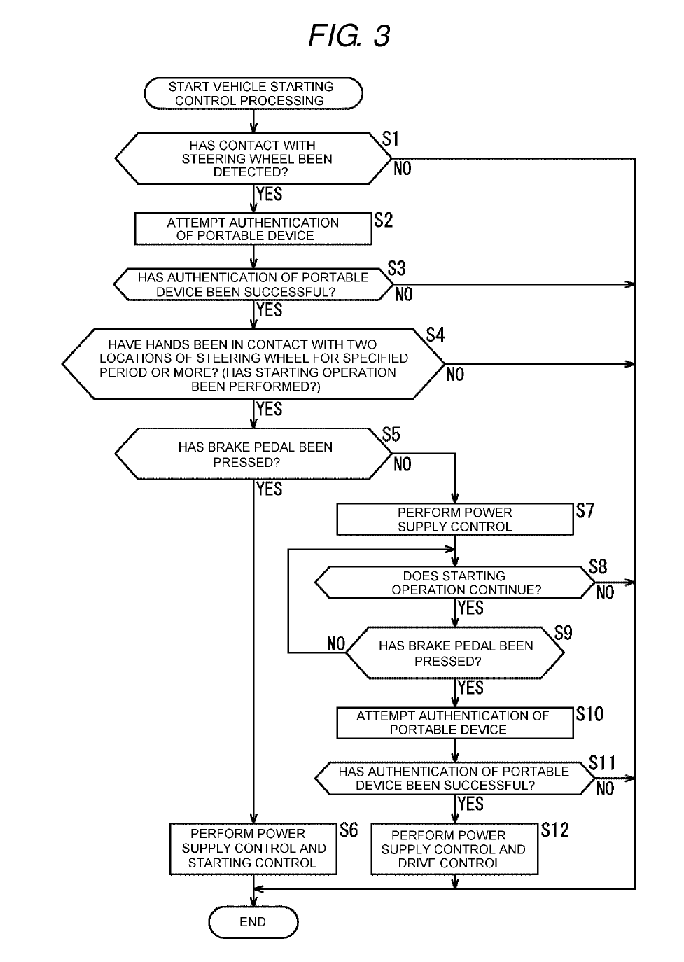

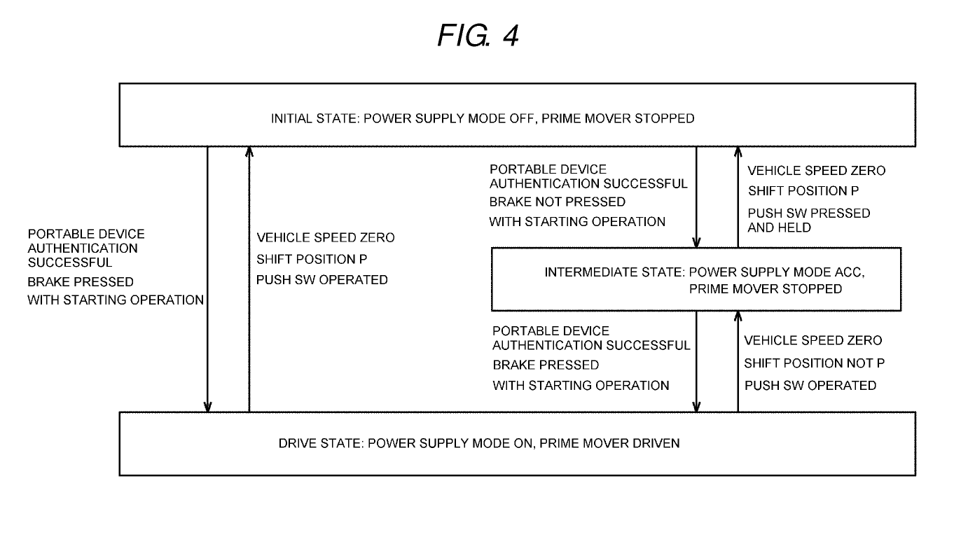

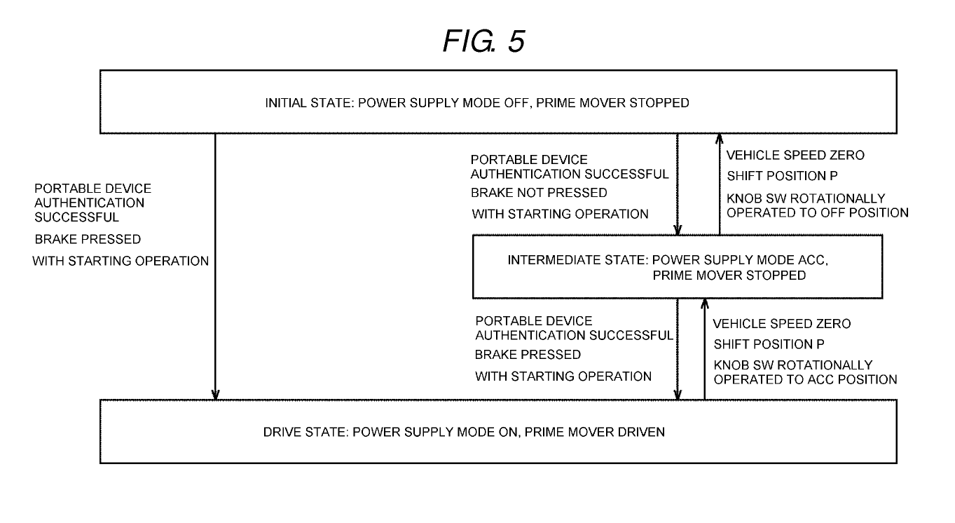

Next, the first embodiment of vehicle starting control processing executed by the vehicle controller 11 will be explained with reference to the flowchart in FIG. 3 and the state transition charts in FIGS. 4 and 5.

Note that the state transition chart in FIG. 4 shows a state transition chart of the vehicle when the power supply and drive operation part 16 is formed by a push switch. On the other hand, the state transition chart in FIG. 5 shows a state transition chart of the vehicle when the power supply and drive operation part 16 is formed by a knob switch.

Further, as below, the case where the power supply modes include three kinds of modes of OFF, accessory, and ON will be explained.

When the power supply mode is set to OFF, the loads of the vehicle (i.e., electric components) are not available except those constantly powered. Further, it is impossible to start the prime mover of the vehicle and it is impossible for the vehicle to travel. Note that, when the power supply and drive operation part 16 is formed by a knob switch, for example, the knob switch is set to the OFF position.

When the power supply mode is set to the accessory mode, power is supplied to part of the loads of the vehicle (for example, the electric components including the accessory socket) and they become available. Further, it is impossible to start the prime mover of the vehicle and it is impossible for the vehicle to travel. Note that, when the power supply and drive operation part 16 is formed by a knob switch, for example, the knob switch is set to the ACC (accessory) position.

When the power supply mode is set to the ON mode, power is supplied to predetermined loads of the vehicle (for example, all of the electric components) and they become available. Further, it becomes possible to start the prime mover of the vehicle and it becomes possible for the vehicle to travel. Note that, when the power supply and drive operation part 16 is formed by a knob switch, for example, the knob switch is set to the ON position.

Note that the processing is executed at predetermined intervals in the initial state of the vehicle shown in FIGS. 4 and 5, i.e., when the power supply mode of the vehicle is OFF, and when the prime mover is stopped.

At step S1, the control unit 36 determines whether or not the contact with the steering wheel 101 has been detected based on the detection result from the contact detection unit 31. If the contact of an object is detected by at least one of the sensor 12L and the sensor 12R, the control unit 36 determines that the contact with the steering wheel 101 has been detected, and the processing moves to step S2. That is, if the contact has been detected at least in one location of the steering wheel 101, the processing moves to step S2 regardless of the location and the number thereof.

At step S2, the authentication unit 32 attempts authentication of the portable device 13. Specifically, the control unit 36 gives a command of execution of the authentication of the portable device 13 to the authentication unit 32. The authentication unit 32 starts transmission of a polling signal or the like, for example, and attempts communication with the portable device 13. When receiving a response signal to the polling signal from the portable device 13, the authentication unit 32 performs authentication processing between the portable device 13 and itself in a predetermined sequence, and notifies the control unit 36 of an authentication result.

Here, the authentication processing performs the following known processing, for example. A response request signal for requesting a replay of authentication information (for example, the ID number of the portable device or the like) is transmitted from the authentication unit 32 to the portable device 13. The portable device 13 that has received the response request signal transmits a response signal containing the authentication information stored in itself to the authentication unit 32. Then, in the authentication unit 32, the portable device 13 is authenticated based on the authentication information contained in the response signal and an authentication result is obtained.

At step S3, the control unit 36 determines whether or not the authentication of the portable device 13 has been successful based on the authentication result from the authentication unit 32. If the determination that the authentication of the portable device 13 has been successful is made, the processing moves to step S4.

At step S4, the control unit 36 determines whether or not hands have been in contact with the two locations on the steering wheel 101 for a specified period or more (whether or not the starting operation has been performed) based on the detection result from the contact detection unit 31. If the contact of an object (the hands of the driver) has been continuously detected for a specified period or more by both the sensor 12L and the sensor 12R after the portable device 13 is successfully authenticated and before a predetermined period elapses, the control unit 36 determines that the starting operation has been performed and the processing moves to step S5.

Here, the condition that the contact of the object has been continuously detected for a specified period or more by both the sensor 12L and the sensor 12R is assumed to be a condition that the state in which the driver holds the right and the left of the ring part of the steering wheel 101 continues, for example. This is a natural movement (natural position) that the driver normally performs at the start of driving.

At step S5, the control unit 36 determines whether or not the brake pedal 14 has been pressed based on the detection result from the brake operation detection unit 33. If the press of the brake pedal 14 is detected after the starting operation is performed and before a predetermined period elapses, the control unit 36 determines that the brake pedal 14 has been pressed and the processing moves to step S6. That is, if the portable device 13 has been successfully authenticated, the starting operation has been performed, and the brake pedal 14 has been pressed, the processing moves to step S6.

At step S6, the control unit 36 performs power supply control and starting control. Specifically, the control unit 36 supplies a command signal for setting the power supply mode to the ON mode to a vehicle power supply (not shown) or a control unit thereof. Thereby, the power supply mode of the vehicle is set to the ON mode. Further, the control unit 36 supplies a command signal for starting the prime mover to the vehicle prime mover (not shown) or a control unit thereof. Thereby, the prime mover of the vehicle is started so that the vehicle can travel. As a result, as shown in FIGS. 4 and 5, the vehicle transitions from an initial state to a drive state. Further, when the power supply and drive operation part 16 is formed by a knob switch, the position of the knob switch is automatically shifted from OFF to ON.

Then, the vehicle starting control processing ends.

On the other hand, at step S5, if the press of the brake pedal 14 is not detected after the starting operation is performed and before the predetermined period elapses, the control unit 36 determines that the brake pedal 14 has not been pressed and the processing moves to step S7.

At step S7, the control unit 36 performs the power supply control. Specifically, the control unit 36 supplies a command signal for setting the power supply mode to the accessory mode to the vehicle power supply (not shown) or the control unit thereof. Thereby, the power supply mode of the vehicle is set to the accessory mode. As a result, as shown in FIGS. 4 and 5, the vehicle transitions from the initial state to an intermediate state. Further, when the power supply and drive operation part 16 is formed by a knob switch, the position of the knob switch is automatically shifted from OFF to ACC.

Note that, in this regard, the power supply mode may be set to the ON mode not the accessory mode.

At step S8, the control unit 36 determines whether or not the same starting operation as that at step S4 continues based on the detection result from the contact detection unit 31. If the detection of the contact of the object by both the sensor 12L and the sensor 12R continues, the control unit 36 determines that the starting operation continues and the processing moves to step S9.

At step S9, the control unit 36 determines whether or not the brake pedal 14 has been pressed based on the detection result from the brake operation detection unit 33. If the determination that the brake pedal 14 has not been pressed is made, the processing returns to step S8.

Then, the processing at steps S8 and S9 is repeatedly executed until stop of the starting operation is determined at step S8 or the press of the brake pedal 14 is determined at step S9.

On the other hand, if the press of the brake pedal 14 is determined at step S9, the processing moves to step S10.

At step S10, the authentication of the portable device 13 is attempted like the processing at step S2.

At step S11, whether or not the authentication of the portable device 13 has been successful is determined like the processing at step S3. If the determination that the authentication of the portable device 13 has been successful is made, the processing moves to step S12.

At step S12, the power supply control and the drive control are performed like the processing at step S6. Thereby, as shown in FIGS. 4 and 5, the vehicle transitions from the intermediate state to the drive state. Further, when the power supply and drive operation part 16 is formed by a knob switch, the position of the knob switch is automatically shifted from ACC to ON.

Note that, if the power supply mode is set to the ON mode in the processing at step S7, the power supply control is omissible at step S12.

Then, the vehicle starting control processing ends.

On the other hand, if the determination that the authentication of the portable device 13 has been failed at step S11, the vehicle starting control processing ends with the vehicle remaining in the intermediate state.

Further, at step S8, if the detection of the contact of the object by at least one of the sensor 12L and the sensor 12R stops, the control unit 36 determines that the starting operation has stopped. Then, the vehicle starting control processing ends with the vehicle remaining in the intermediate state.

Furthermore, at step S4, if the contact of the object is not continuously detected in a specified period or more by at least one of the sensor 12L and the sensor 12R after the portable device 13 is successfully authenticated and before a predetermined period elapses, the control unit 36 determines that the starting operation has not been performed. Then, the vehicle starting control processing ends with the vehicle remaining in the initial state.

Further, if the determination that the authentication of the portable device 13 has been failed is made at step S3, the vehicle starting control processing ends with the vehicle remaining in the initial state.

Furthermore, at step S1, if the determination that the contact with the steering wheel 101 has not been detected is made, the vehicle starting control processing ends with the vehicle remaining in the initial state.

In the above described manner, the driver who carries the legitimate portable device 13 may start the vehicle only by the natural movement at the start of driving of holding the steering wheel 101 with both hands for a specified period or more and pressing the brake pedal 14 without any other special operation. Further, the vehicle is not started without the above series of movement, and thereby, the start of the vehicle without intention due to erroneous operation may be prevented and safety may be secured. Further, the vehicle is not started unless the portable device 13 is successfully authenticated, and thereby, a theft of the vehicle or the like may be prevented.

Note that, in the case of the example in FIG. 4, in the drive state, when the vehicle speed is set to zero and the shift position is set to parking (P), if the push switch forming the power supply and drive operation part 16 is operated, the vehicle transitions to the initial state. Further, in the drive state, when the vehicle speed is set to zero and the shift position is set to another position than parking (P), if the push switch forming the power supply and drive operation part 16 is operated, the vehicle transitions to the intermediate state. Furthermore, in the intermediate state, when the vehicle speed is set to zero and the shift position is set to parking (P), if the push switch forming the power supply and drive operation part 16 is pressed and held, the vehicle transitions to the initial state.

Further, in the case of the example in FIG. 5, in the drive state, when the vehicle speed is set to zero and the shift position is set to parking (P), if the switch knob forming the power supply and drive operation part 16 is rotationally operated to the ACC position, the vehicle transitions to the intermediate state. Furthermore, in the intermediate state, when the vehicle speed is set to zero and the shift position is set to parking (P), if the switch knob forming the power supply and drive operation part 16 is rotationally operated to the OFF position, the vehicle transitions to the initial state.

In addition, in either case of FIGS. 4 and 5, by operating the push switch or knob switch as in related art, the vehicle may be started or power supply may be started.

### Second Embodiment of Vehicle Starting Control Processing

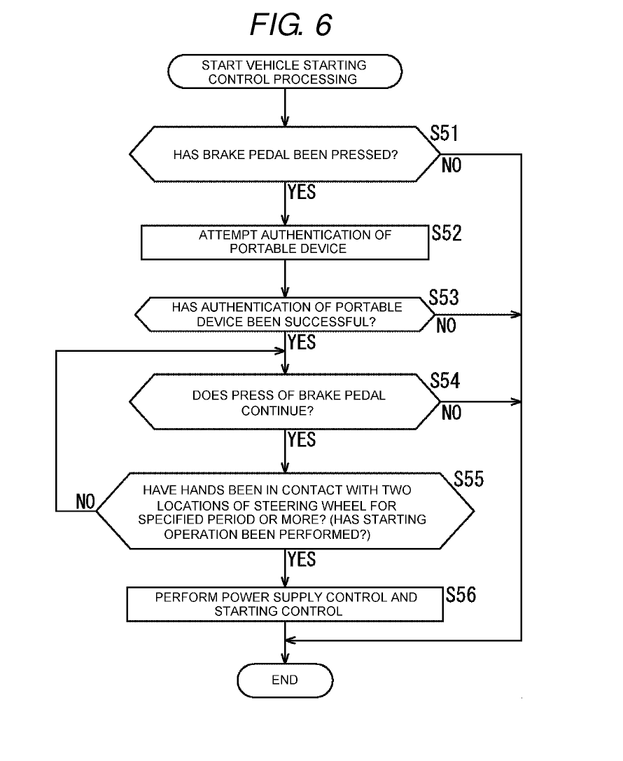

Next, the second embodiment of vehicle starting control processing executed by the vehicle controller 11 will be explained with reference to the flowchart in FIG. 6.

Note that the processing is executed at predetermined intervals when the vehicle is in the initial state, for example.

At step S51, whether or not the brake pedal 14 has been pressed is determined like the processing at step S9 in FIG. 3. If the determination that the brake pedal 14 has been pressed is made, the processing moves to step S52.

At step S52, the authentication of the portable device 13 is attempted like the processing at step S2 in FIG. 3.

At step S53, whether or not the authentication of the portable device 13 has been successful is determined like the processing at step S3 in FIG. 3. If the determination that the authentication of the portable device 13 has been successful is made, the processing moves to step S54.

At step S54, the control unit 36 determines whether or not the press of the brake pedal 14 continues based on the detection result from the brake operation detection unit 33. If the determination that the press of the brake pedal 14 continues is made, the processing moves to step S55.

At step S55, the control part 36 determines whether or not hands have been in contact with the two locations on the steering wheel 101 for a specified period or more (whether or not the starting operation has been performed) based on the detection result from the contact detection part 31. If the contact of the object is not continuously detected in a specified period or more by at least one of the sensor 12L and the sensor 12R, the control unit 36 determines that the starting operation has not been performed and the processing returns to step S54.

Then, at step S54, the processing at steps S54 and S55 is repeatedly executed until stop of the press of the brake pedal 14 is determined at step S54 or performance of the starting operation is determined at step S55.

On the other hand, at step S55, if the contact of the object is continuously detected in a specified period or more by both of the sensor 12L and the sensor 12R at the same time, the control unit 36 determines that the starting operation has been performed and the processing moves to step S56.

At step S56, the power supply control and the starting control are performed like the processing at step S6 in FIG. 3, and the vehicle transitions from the initial state to the drive state.

Then, the vehicle starting control processing ends.

On the other hand, at step S54, if the stop of the press of the brake pedal 14 is determined, the vehicle starting control processing ends with the vehicle remaining in the initial state.

Further, if the determination that the press of the brake pedal 14 has not been detected is made at step S51 or the determination that the authentication of the portable device 13 has been failed is made at step S53, the vehicle starting control processing ends with the vehicle remaining in the initial state.

In the above described manner, the driver who carries the legitimate portable device 13 may start the vehicle only by the natural movement at the start of driving of pressing the brake pedal 14 and then holding the steering wheel 101 with both hands without any other special operation. Further, the vehicle is not started without the above series of movement, and thereby, the start of the vehicle without intention due to erroneous operation may be prevented and safety may be secured. Further, the vehicle is not started unless the portable device 13 is successfully authenticated, and thereby, a theft of the vehicle or the like may be prevented.

Note that, if the determination that the starting operation has not been performed is made at step S55, the processing may return to step S52 and the authentication processing may be performed each time. Further, the authentication processing may be performed at predetermined intervals after the portable device 13 has been successfully authenticated at step S53 and while the determination processing at step S54 and step S55 is repeated.

### Third Embodiment of Vehicle Starting Control Processing

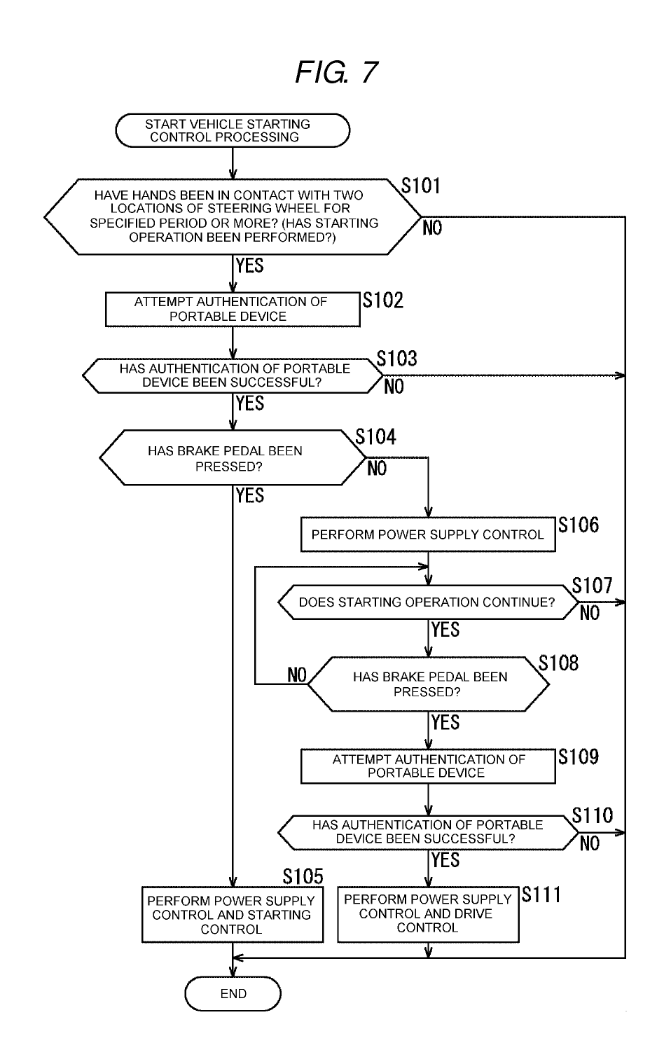

Next, the third embodiment of vehicle starting control processing executed by the vehicle controller 11 will be explained with reference to the flowchart in FIG. 7.

Note that the processing is executed at predetermined intervals when the vehicle is in the initial state, for example.

At step S101, whether or not hands have been in contact with the two locations on the steering wheel 101 for a specified period or more (whether or not the starting operation has been performed) is determined like the processing at step S55 in FIG. 6. If the determination that the starting operation has been performed is made, the processing moves to step S102.

At step S102, the authentication of the portable device 13 is attempted like the processing at step S2 in FIG. 3.

At step S103, whether or not the authentication of the portable device 13 has been successful is determined like the processing at step S3 in FIG. 3. If the determination that the authentication of the portable device 13 has been successful is made, the processing moves to step S104.

At step S104, the control unit 36 determines whether or not the brake pedal 14 has been pressed based on the detection result from the brake operation detection unit 33. If the press of the brake pedal 14 is detected after the portable device 13 is successfully authenticated and before a predetermined period elapses, the control unit 36 determines that the brake pedal 14 has been pressed and the processing moves to step S105.

At step S105, the power supply control and the starting control are performed like the processing at step S6 in FIG. 3, and the vehicle transitions from the initial state to the drive state.

Then, the vehicle starting control processing ends.

On the other hand, at step S104, if the determination that the brake pedal 14 has not been pressed is made, the processing moves to step S106.

Then, at steps S106 to S111, the same processing as that at steps S7 to S12 in FIG. 3 is executed and the vehicle starting control processing ends.

On the other hand, if the determination that the starting operation has not been performed at step S101 or the determination that the authentication of the portable device 13 has been failed is made at step S103, the vehicle starting control processing ends with the vehicle remaining in the initial state.

In the above described manner, the driver who carries the legitimate portable device 13 may start the vehicle only by the natural movement at the start of driving of holding the steering wheel 101 with both hands and then pressing the brake pedal 14 without any other special operation. Further, the vehicle is not started without the above series of movement, and thereby, the start of the vehicle without intention due to erroneous operation may be prevented and safety may be secured. Further, the vehicle is not started unless the portable device 13 is successfully authenticated, and thereby, a theft of the vehicle or the like may be prevented.

### Fourth Embodiment of Vehicle Starting Control Processing

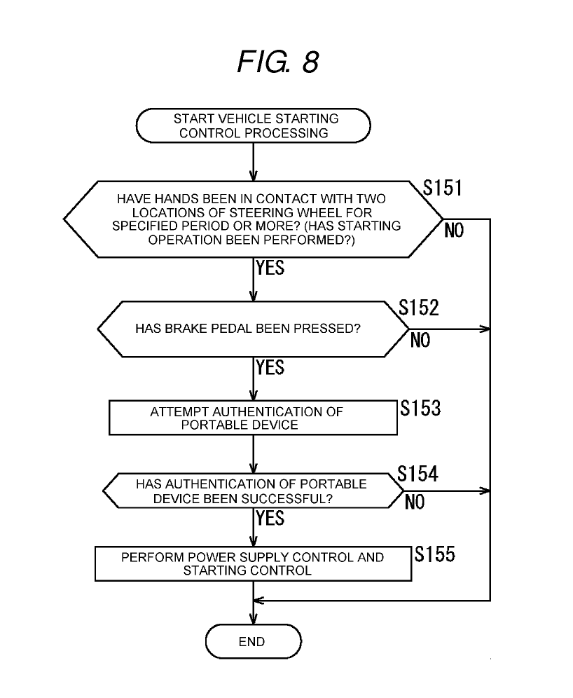

Next, the fourth embodiment of vehicle starting control processing executed by the vehicle controller 11 will be explained with reference to the flowchart in FIG. 8.

Note that the processing is executed at predetermined intervals when the vehicle is in the initial state, for example.

At step S151, whether or not hands have been in contact with the two locations on the steering wheel 101 for a specified period or more (whether or not the starting operation has been performed) is determined like the processing at step S55 in FIG. 6. If the determination that the starting operation has been performed is made, the processing moves to step S152.

At step S152, whether or not the brake pedal 14 has been pressed is determined like the processing at step 5 in FIG. 3. If the determination that the brake pedal 14 has been pressed is determined, the processing moves to step S153.

At step S153, the authentication of the portable device 13 is attempted like the processing at step S2 in FIG. 3.

At step S154, whether or not the authentication of the portable device 13 has been successful is determined like the processing at step S3 in FIG. 3.

At step S155, the power supply control and the starting control are performed like the processing at step S6 in FIG. 3, and the vehicle transitions from the initial state to the drive state.

Then, the vehicle starting control processing ends.

On the other hand, if the determination that the starting operation has not been performed is made at step S151, if the determination that the brake pedal 14 has not been pressed is made at step S152, or if the determination that the authentication of the portable device 13 has been failed is made at step S154, the vehicle starting control processing ends with the vehicle remaining in the initial state.

In the above described manner, the driver who carries the legitimate portable device 13 may start the vehicle only by the natural movement at the start of driving of holding the steering wheel 101 with both hands and pressing the brake pedal 14 without any other special operation. Further, the vehicle is not started without the above series of movement, and thereby, the start of the vehicle without intention due to erroneous operation may be prevented and safety may be secured. Further, the vehicle is not started unless the portable device 13 is successfully authenticated, and thereby, a theft of the vehicle or the like may be prevented.

### 2. Modified Examples

As below, modified examples of one or more of the above described embodiments will be explained.

For example, if one of the sensor 12L and the sensor 12R breaks down, it is impossible to detect the above described starting operation. On the other hand, for example, if only one of the sensor 12L and the sensor 12R continuously detects the contact of the object for a specified period or more, i.e., if the contact with one location of the steering wheel 101 is detected for a specified period or more, breakdown of one of the sensors may be determined. Note that the specified period is set to a value of the specified period used for determination of the starting operation or more, for example.

Then, if breakdown of one of the sensors is determined, manual operation of the power supply and drive operation part 16 to start the vehicle may be prompted, for example. For example, it is conceivable that the control unit 36 performs control of blinking the power supply and drive operation part 16 or an LED provided nearby or the like and allowing an instrument panel to display a prompt of manual operation.

Further, when the sensors 12L, 12R are formed by sensors requiring power, it is necessary to supply power to the sensors 12L, 12R before the driver comes into contact with the steering wheel 101. In this case, for reduction of power consumption, for example, power supply to the sensors 12L, 12R may be started when a person getting into the vehicle is detected (e.g., when closing of the door of the vehicle is detected or the like).

Furthermore, it is possible to authenticate the portable device 13 at other timing than the above described timing. For example, the portable device 13 may be authenticated in advance when a person getting into the vehicle is detected (e.g., when closing of the door of the vehicle is detected or the like).

Further, in the vehicle starting control processing in FIGS. 3 and 7, the portable device 13 is authenticated again when the vehicle transitions from the intermediate state to the drive state, however, the re-authentication is omissible.

Furthermore, although the shift position at the vehicle starting control processing is not particularly specified in the above description, for example, the above described vehicle starting control processing may be performed only when the shift position is set to a predetermined position (e.g., parking).

Further, the locations where the sensors of the steering wheel 101 are provided are not limited to the example in FIG. 2 as long as the sensors may detect the driver holding the steering wheel 101 with hands. For example, the sensors may be provided in three or more locations. Or, for example, one sensor that can detect the contact positions may be provided in the whole ring part of the steering wheel 101, and sensor data indicating the specific contact positions may be supplied to the contact detection unit 31. Further, depending on the locations where the sensors are provided and the position of the hand of the driver, it is assumed that, when the driver holds the steering wheel 101 with hands, the contact with the steering wheel 101 are detected in three or more locations.

Furthermore, the explanation of the vehicle starting control processing is made assuming the case where the vehicle is mainly an automobile such as a passenger car, a bus, or a truck, however, one or more embodiments of the invention may be applied to the case where the vehicle is a two-wheeled vehicle or three-wheeled vehicle with prime mover such as a motorbike. In this case, for example, the sensors 12L, 12R are respectively provided on the right and left handle bars (grips) as the steering part instead of the steering wheel 101. Further, for example, as the operation of the brake, the operation of a brake lever, foot brake, or the like is detected instead of the brake pedal 14.

Further, for example, if it is impossible to authenticate the portable device 13 due to the dead battery or the like, for example, the prime mover may be started using a push switch with coil in related art to start the prime mover by power supply and push operation with the coil.

[Configuration Example of Computer]

The above described series of processing may be executed using hardware or executed using software. When the series of processing is executed using software, a program forming the software is installed in a computer. Here, the computer includes a computer incorporated in specialized hardware.

Further, the program to be executed by the computer may be recorded and provided in a removable medium as a package medium, for example. Furthermore, the program may be provided via a wireless or wired transmission medium including a local area network, CAN, the Internet, and Digital Satellite Broadcasting.

In addition, the program may be installed in a ROM and a memory unit in advance, for example.

Note that the program to be executed by the computer may be a program for temporal sequence processing along the sequence explained in the specification, or a program for processing at necessary timing in parallel or when a calling is made.

Further, in the specification, the system means assembly of a plurality of component elements (units, modules (components), etc.) and it doesn't matter whether or not all component elements are within the same housing. Therefore, a plurality of units housed in separate housings and connected via a network and one unit with a plurality of modules housed in one housing are systems.

Furthermore, the invention is not limited to the above described embodiments, and various changes may be made without departing from the scope of the invention.

Further, the respective steps explained in the above described flowcharts may be executed by one unit or shared and executed by a plurality of units.

Furthermore, when one step contains a plurality of pieces of processing, the plurality of pieces of processing contained in the one step may be executed by one unit or shared and executed by a plurality of units.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A vehicle controller comprising:
a brake operation detector that detects operation of a brake of a vehicle;
a contact detector that detects contact of hands with a steering part of the vehicle;
an authentication unit that makes wireless communication with a portable device having authentication information and authenticates the portable device; and
a controller that controls power supply of the vehicle and driving of a prime mover of the vehicle,
wherein, if the portable device has been successfully authenticated, the operation of the brake has been detected, and contact of the hands with at least two locations of the steering part has been detected for a specified period or more, the controller performs control to start power supply to a predetermined load of the vehicle and start the prime mover.

2. The vehicle controller according to claim 1,
wherein, if the contact of the hands with the steering part has been detected under a condition that the power supply to the load and the prime mover are stopped, the authentication unit authenticates the portable device,
wherein, if the contact of the hands with at least two locations of the steering part has been detected for a specified period or more and the operation of the brake has been detected under a condition that the portable device has been successfully authenticated, the controller performs control to start power supply to the load and start the prime mover, and
wherein, if the contact of the hands with at least two locations of the steering part has been detected for a specified period or more and the operation of the brake has not been detected under the condition that the portable device has been successfully authenticated, the controller performs control to start power supply to at least apart of the load and not to start the prime mover, and then, if the operation of the brake is detected under a condition that the contact of the hands with at least two locations of the steering part has been continuously detected, the controller performs control to start the prime mover.

3. The vehicle controller according to claim 2,
wherein, if the operation of the brake is detected under a condition that the control to start power supply to at least a part of the load is performed, and then, the contact of the hands with at least two locations of the steering part has been continuously detected, the authentication unit authenticates the portable device, and
wherein, if the portable device has been successfully authenticated, the controller performs control to start the prime mover.

4. The vehicle controller according to claim 1,
wherein, if the operation of the brake is detected under a condition that the power supply to the load and the prime mover are stopped, the authentication unit authenticates the portable device, and
wherein, if the contact of the hands with at least two locations of the steering part has been detected for a specified period or more under a condition that the portable device has been successfully authenticated and the operation of the brake has been detected, the controller performs control to start power supply to the load and start the prime mover.

5. The vehicle controller according to claim 1,
wherein, if the contact of the hands with at least two locations of the steering part has been detected under a condition that the power supply to the load and the prime mover are stopped, the authentication unit authenticates the portable device,
wherein, if the operation of the brake is detected under a condition that the portable device has been successfully authenticated, the controller performs control to start power supply to the load and start the prime mover, and
wherein, if the operation of the brake is not detected under the condition that the portable device has been successfully authenticated, the controller performs control to start power supply to at least a part of the load and not to start the prime mover, and then, if the operation of the brake is detected under a condition that the contact of the hands with at least two locations of the steering part has been continuously detected, the controller performs control to start the prime mover.

6. The vehicle controller according to claim 5,
wherein, if the operation of the brake is detected under a condition that the control to start power supply to at least a part of the load is performed, and then, the contact of the hands with at least two locations of the steering part has been continuously detected, the authentication unit authenticates the portable device, and
wherein, if the portable device has been successfully authenticated, the controller performs control to start the prime mover.

7. The vehicle controller according to claim 1,
wherein, if the operation of the brake is detected and the contact of the hands with at least two locations of the steering part has been detected for a specified period or more under a condition that the power supply to the load and the prime mover are stopped, the authentication unit authenticates the portable device, and
wherein, if the portable device has been successfully authenticated, the controller performs control to start power supply to the load and start the prime mover.

8. The vehicle controller according to claim 1, further comprising:
a push-button operation part that operates starting and stopping of the prime mover,
wherein, if the portable device has been successfully authenticated, the operation of the brake has been detected, and the contact of the hands with one location of the steering part has been detected for a specified period or more, the controller determines abnormality of the contact detector and prompts a user to operate the operation part.

9. A vehicle control method comprising:
a brake operation detection step of detecting operation of a brake of a vehicle;
a contact detection step of detecting contact of hands with a steering part of the vehicle;
an authentication step of making wireless communication with a portable device having authentication information and authenticating the portable device; and
a starting control step of performing control to start power supply to a predetermined load of the vehicle and start a prime mover of the vehicle if the portable device has been successfully authenticated, the operation of the brake has been detected, and contact of the hands with at least two locations of the steering part has been detected for a specified period or more.
